(19) United States
(12) Patent Application Publication
(10) Pub. No.: US 2004/0202481 A1
(43) Pub. Date: Oct. 14, 2004

(54) Systems and methods for recovering a clock from optical data

(76) Inventor: Richard K. Karlquist, Cupertino, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/412,374

(22) Filed: Apr. 11, 2003

(51) Int. Cl. H04B 10/00

(52) U.S. Cl. 398/155

(57) ABSTRACT

Representative embodiments are directed to systems and methods that recover a clock from optical NRZ data. A first photodetector and a second photodetector are connected in series across complementary power supplies. The first photodetector is illuminated with the optical NRZ data. The second photodetector is illuminated with a delayed version of the optical NRZ data. A resistor may provide a path from a node between the photodetectors to ground. By utilizing the delayed version to illuminate the second photodetector, current is only conducted through the resistor when a data transition occurs. Furthermore, suitable rectifying structure may be employed to combine positive and negative pulses to form an output signal. The output signal possesses a spectral component at the frequency of the clock. I The output signal may be filtered to recover the clock associated with the received NRZ data.

### CROSS-REFERENCE TO RELATED APPLICATIONS

This application is related to concurrently filed and commonly assigned U.S. patent application Ser. No. DOCKET NO: 10020557-1, entitled “SYSTEM AND METHODS OF RECOVERING A CLOCK FROM NRZ DATA,” which is incorporated herein by reference.

### TECHNICAL FIELD

The present invention is generally related to recovery of a clock from an optical signal.

### BACKGROUND

Data in optical communication networks, such as Synchronous Optical Networks (SONETs), is typically transmitted in non-return-to-zero (NRZ) format in the optical domain via pulses of light. NRZ refers to an encoding scheme in which there is no return to a reference between encoded bits. Instead, the signaling remains at an “on” state for consecutive “ones” and remains at an “off” state for consecutive “zeros” for optical data. Additionally, NRZ communication systems embed the clock in the data. Thus, in data transmission systems that utilize NRZ signaling, it is necessary to recover the clock based on the timing of the data transitions in the data stream.

Jitter measurement is an important performance test of synchronous optical communication systems. A conventional system to measure jitter is shown in FIG. 1. In system 100, optical data is converted into electrical data by optical-to-electrical converter 101 (a photodetector). The electrical data is then analyzed utilizing all-electronic jitter test set 102. However, at state of the art optical communication data rates (such as 40 Gb/s), substantially all electrical components including connectors and cables, add a degree of jitter. Thus, the electrical impairments associated with electrical jitter test set 102 establish a jitter floor for any jitter measurements.

To perform jitter measurements associated with NRZ data, it is necessary to recover the clock from the data. A commonly utilized method for recovering the embedded clock is to implement a circuit that generates an impulse whenever there is a data transition. Circuit 200 of FIG. 2 implements this common method. Circuit 200 receives data at splitter 201. Splitter 201 provides two separate circuit paths to exclusive-OR (XOR) gate 203. In one of the circuit paths, delay element 202 provides a one-half unit interval (UI) delay. By delaying the data provided to XOR gate 203, circuit 200 will produce a pulse whenever there is a data transition (from “zero” to “one” or vice versa). The pulses will contain a spectral component at the clock frequency that can be filtered by band-pass filter 204 to recover the embedded clock. Circuit 200 is associated with a number of disadvantages. First, circuit 200 requires logic technology that can switch in less time than one-half unit interval. Secondly, XOR gate 203 may add an appreciable amount of jitter to the recovered clock.

### BRIEF SUMMARY

Representative embodiments are directed to systems and methods which recover a clock from optical NRZ data. Representative embodiments may split optical NRZ data to generate two versions of the optical NRZ data. One of the versions of the optical NRZ data may be delayed by one-half unit interval with respect to the other version. After delaying one of the versions, both versions are utilized to illuminate respective photodiodes. Also, the photodiodes may be connected in series across complementary power supplies. A load resistor may provide a path from a node between the photodiodes to ground. When the optical NRZ is steadily off, neither photodiodes are illuminated, no current is conducted, and there is no current flowing through the load resistor. When the optical NRZ is steadily on, both photodiodes are illuminated and conduct current. Because both photodiodes conduct current, there is no net current in the load resistor. However, when only one of the photodiodes is illuminated, current only flows through the illuminated photodiode and, hence, current flows through the load resistor. Thus, either a positive pulse or negative pulse is generated depending upon the type of data transition. The positive and negative pulses may be rectified and combined by suitable structure to generate an output signal that has a spectral component at the clock frequency. The output signal may be filtered to recover the clock associated with the received NRZ data.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 depicts a jitter test system according to the prior art;

FIG. 2 depicts a clock recovery circuit according to the prior art; and

FIG. 3 depicts an clock recovery circuit according to embodiments of the present invention.

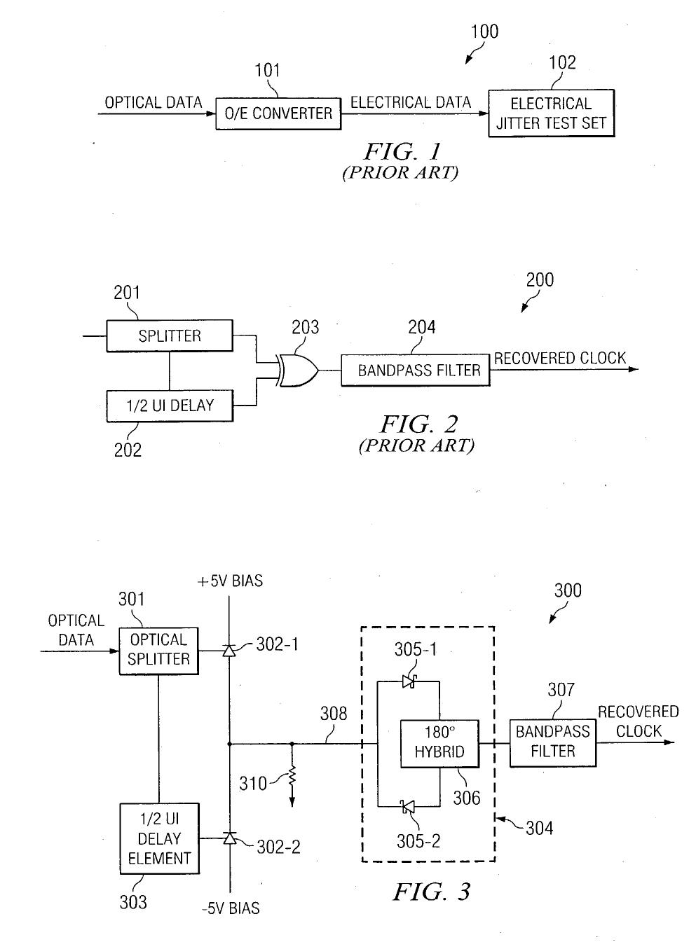

### DETAILED DESCRIPTION

FIG. 3 depicts system 300 for recovering a clock from optical NRZ data according to representative embodiments. System 300 receives optical data at optical splitter 301. Optical splitter 301 splits the optical data along two separate paths. Along the first path, the optical data propagates until the optical data illuminates a suitable photodetector such as photodiode 302-1. Along the second path, the optical data propagates and is delayed by one-half unit interval relative to the other path by delay element 303. After being delayed, the optical data illuminates photodiode 302-2. Each of photodiodes 302-1 and 302-2 conduct current when illuminated. Photodiodes 302-1 and 302-2 may advantageously draw no or negligible “dark” current (i.e., the current that is conducted when no light is incident thereon). Photodiodes 302-1 and 302-2 may be connected across complementary power supplies (shown as, for example, +5V bias and −5V bias). Furthermore, load resistor 310 is connected to node 308 that is between photodiodes 302-1 and 302-2. Load resistor 310 is also connected to ground.

When the optical data is steadily off (i.e., logical “zeros”), both of photodiodes 302-1 and 302-2 do not conduct current. Accordingly, no current is conducted to ground through load resistor 310 and the voltage of node 308 is zero. When the optical data is steadily on (i.e., logical “ones”), both of photodiodes 302-1 and 302-2 conduct current. The current is conducted from one of the power supplies to the other supply. Thus, again, no net current flows through load resistor 310 and the voltage of node 308 is zero. However, when a transition occurs, the delay causes one of photodiodes 302 to be illuminated while the other is not illuminated for a period of time equal to one-half unit interval. In this case, current flows through only one of photodiodes 302-1 and 302-2. The voltage at node 308 will be pulled toward the respective power supply associated with the illuminated photodiode. Thus, when a transition occurs from “zero” to “one,” a positive pulse will be produced at node 308. Likewise, when a transition occurs from “one” to “zero,” a negative pulse will be produced at node 308.

Because the pulses for positive transitions are opposite in polarity to the pulses for negative transitions, and there are inherently an equal number of positive and negative transitions, no net output occurs at the clock frequency. Representative embodiments address this issue by utilizing rectifying block 304 to separate the positive pulses from the negative pulses. Rectifying block 304 may be implemented in a number of ways. For example, rectifying block 304 may be implemented using diodes (e.g., Schottky diodes) connected in series. When a positive pulse is produced on node 308, diode 305-1 conducts current. When a negative pulse is produced on node 308, diode 305-2 conducts current in the opposite direction. By coupling diodes 305-1 and 305-2 to 180° hybrid coupler 306, a positive pulse is produced before band-pass filter 307 for both types of data transitions. The output from 180° hybrid coupler 306 possesses a spectral component at the clock frequency of the received optical data. The output may then be filtered by band-pass filter 307 to generate the recovered clock.

It shall be appreciated that representative embodiments may utilize variations of the design shown in FIG. 3. For example, rectifying block 304 may be implemented utilizing shunt rectifiers rather than series rectifiers. Additionally, it is not required to combine the signals from diodes 305-1 and 305-2. It is possible to recover the embedded clock by utilizing only positive transitions or negative transitions.

Representative embodiments are advantageous for several reasons. Specifically, the use of photodiodes 302-1 and 302-2 and load resistor 310 appreciably reduces the amount of jitter added to the recovered clock as compared to the use of an exclusive-or gate. Accordingly, jitter measurements of optical communication systems according to representative embodiments are associated with a lower jitter floor than jitter measurements performed utilizing known techniques. Thus, the performance of an optical communication system may be determined more precisely. Additionally, the use of photodiodes 302-1 and 302-2 and load resistor 310 are not subject to frequency constraints associated with electronic logic devices. Specifically, Schottky diodes are capable of switching much faster than exclusive-or gates. Thus, representative embodiments may exhibit superior performance at higher frequencies than known clock recovery circuits.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for recovering a clock from optical non-return-to-zero (NRZ) data, comprising:
a first photodetector that receives said optical NRZ data;
a second photodetector that receives a delayed version of said optical NRZ data, wherein said first photodetector and said second photodetector are connected in series;
a resistor, connected to a node between said first photodetector and said second photodetector, that draws current when only one of said first photodetector and said second photodetector is illuminated; and
a splitting structure that separates positive pulses from negative pulses when said resistor draws current.

2. The system of claim 1 wherein said first photodetector and said second photodetector are photodiodes.

3. The system of claim 1 further comprising:
a splitter for splitting said optical NRZ data into a first version and a second version.

4. The system of claim 3 further comprising:
a delay element for delaying said second version by one-half of a unit interval.

5. The system of claim 4 wherein said first version illuminates said first photodetector and said second version illuminates said second photodetector.

6. The system of claim 1 wherein said first photodetector and said second photodetector are connected across complementary power supplies.

7. The system of claim 1 wherein said splitting structure includes a first diode and a second diode coupled to said resistor.

8. The system of claim 7 wherein said first and second diodes are Schottky diodes.

9. The system of claim 7 wherein said first diode and said second diode are connected as series rectifiers.

10. The system of claim 7 wherein said first diode and said second diode are connected as shunt rectifiers.

11. The system of claim 7 further comprising:
a 180° hybrid coupler, coupled to said first and second diodes, that generates an output signal that has a spectral component at a frequency of said clock.

12. The system of claim 11 further comprising:
a band-pass filter for filtering said output signal to generate said clock.

13. A method for recovering a clock from optical non-return-to-zero (NRZ) data, comprising:
illuminating a first photodetector with said optical NRZ data;
illuminating a second photodetector with a delayed version of said optical NRZ data, wherein said first photodetector and said second photodetector are connected in series across complementary power supplies;
conducting current through a resistor, connected to a node between said first photodetector and said second photodetector, when only one of said first photodetector and said second photodetector is illuminated; and
separating negative pulses and positive pulses that occur on said node when said resistor conducts current.

14. The method of claim 13 wherein said first and second photodetectors are photodiodes.

15. The method of claim 13 further comprising:
splitting said optical NRZ data to generate a first version and a second version of said optical NRZ data.

16. The method of claim 15 further comprising:
delaying said second version by one-half unit interval.

17. The method of claim 13 wherein said splitting comprises:
conducing positive pulses utilizing a first diode; and
conducting negative pulses utilizing a second diode.

18. The method of claim 17 wherein said first and second diodes are Schottky diodes.

19. The method of claim 17 further comprising:
inverting one of said positive pulses and said negative pulses; and
coupling said inverted pulses and said other pulses to generate an output signal that has a spectral component at a frequency of said clock.

20. The method of claim 19 further comprising:
filtering said output signal to generate said clock.

21. A system for recovering a clock from optical non-return-to-zero (NRZ) data, comprising:
first photodetector means for conducting current when illuminated by optical NRZ data;
second photodetector means for conducting current when illuminated by a delayed version of said optical NRZ data, wherein said first and second photodetector means are connected in series;
resistor means for drawing current from a node connected between said first and second photodetector means when only one of said first and second photodetector means is illuminated;
first rectifying means for rectifying positive pulses generated on said node when said resistor means draws current;
second rectifying means for rectifying negative pulses generated on said node when said resistor means draws current; and
coupling means for combining outputs from said first and second rectifying means to generate an output signal that has a spectral component at a frequency of said clock.

22. The system of claim 21 further comprising:
filtering means for filtering said output signal to generate said clock.

23. The system of claim 21 wherein said first and second photodetector means are photodiodes.
